(19) United States
(12) Patent Application Publication
(10) Pub. No.: US 2017/0136915 A1
(43) Pub. Date: May 18, 2017

(54) Power System Using Switched Reluctance Motor as Power Transformer

(71) Applicant: SICHUAN NEW ENERGY EXCHANGE TECHNOLOGY CO., LTD, Chengdu, Sichuan (CN)

(72) Inventor: Ke MAO, Chengdu, Sichuan (CN)

(21) Appl. No.: 15/327,166

(22) PCT Filed: Feb. 11, 2015
(86) PCT No.: PCT/CN2015/072718

§ 371 Date: Jan. 18, 2017

(30) Foreign Application Priority Data
Jul. 18, 2014 (CN) 201410343617.3

(51) Int. Cl. B60L 15/02; H02K 47/00; B60L 11/18

(52) U.S. Cl. CPC B60L 15/02; B60L 11/1868; H02K 47/00; B60L 11/1803; B60L 2210/40

(57) ABSTRACT

Disclosed is a power system using a switched reluctance motor as a power transformer. The power system comprises a motor controller unit, an electricity storage device, two power converters and a motor set, wherein the electricity storage device, the power converters and a motor are respectively connected to the motor controller unit; one power converter is connected to the electricity storage device, and the other power converter is connected to an external power source; and the two power converters are respectively connected to the motor set. The power system can output relatively high power efficiently using a relatively low system voltage, thereby having relatively high differential tolerance of electricity storage devices, and can use different types of electricity devices in a mixing mode, thereby having strong fault-tolerant capability, good system manufacturing flexibility, high system compactness, low weight and low costs.

### FIELD OF THE INVENTION

The invention relates to a power system, especially a power system using a switched reluctance motor as a power transformer.

### DESCRIPTION OF THE RELATED ART

The main components of new energy electric vehicles are power batteries, motors and energy conversion control system, whereas the power battery needs rapid charging, security and other high properties, and is the most profitable part with highest technical threshold, but satisfactory solution is not available now. The new energy vehicles are very concerned about batteries and require the batteries to have such properties as high specific energy, high specific power, fast charge and deep discharging at the minimum cost and longest service life. The technologies for conventional lead-acid battery, nickel-cadmium battery and nickel-hydrogen battery are relatively mature, but there are considerable problems when such batteries are used as power batteries of the vehicles. At present, more and more automobile manufacturers choose lithium batteries as the power batteries of new energy vehicles.

The lithium battery is characterized by small size, light weight, high operating voltage (3 times of that of the nickel-cadmium battery and hydrogen-nickel battery), high specific energy (up to 200 WH/kg, which is 3 times of that of the hydrogen-nickel battery), long cycle life, low self-discharge rate, no memory effect, no pollution, good safety, etc. Currently, the development of the power lithium-ion battery is blocked by poor safety performance and automotive power battery management system. For the safety performance, the high energy density, high operating temperature and adverse working environment of the lithium-ion power battery greatly reduce the safety performance. Based on the people-oriented security concept, users put forward very high requirements for safety of the batteries. For the automotive power battery management system, the operating voltage of a single power lithium-ion battery and a single lithium-iron battery is 3.7V and 3.2V respectively , and a plurality of batteries are connected in series to boost the voltage up to hundreds of volts to meet the power requirement of a vehicle. However, because the batteries are unable to evenly charge and discharge, the single batteries in a plurality of battery packs in series are liable to unbalance in charge and discharge, which leads to undercharge and over-discharge, further results in sharp deterioration in battery performance. Eventually, the entire group of batteries is unable to work or even scrapped, and the service life and reliability of the batteries are greatly affected. Take the lithium iron phosphate battery for example, a single cell can normally charge and discharge for 2000 times, the overall battery pack can only charge and discharge for 300 to 500 times. Such battery packs have limited service life. For example, the batteries for electric vehicles used in the early stage of the Beijing Olympic Games were only used for 3 months. Therefore, the cost of the power batteries increases, which suppresses the popularization of the electric vehicles.

The “charge and discharge times of single cell” results from the professional operation in laboratory environment. However, the service life of batteries is affected by temperature, humidity and vibration in the practical environment. Therefore, a conclusion is drawn based on technology and cost that if a lithium battery power system can be charged and discharged for 700 to 800 times, and the cost equals that of fuel vehicles; and if a lithium battery power system can be charged and discharged for 1000 times, the total cost is less than that of the fuel vehicles. However, it is still a worldwide problem to achieve more than 1000 times of charge and discharge.

The cost of the power system accounts for about half of total cost of an electric vehicle. Therefore, despite the national policy support and subsidies, the expansion of related pilot cities and encouragement for development of the electric vehicle industry, the development of the electric vehicles is not satisfactory due to defects in the battery technology. Therefore, even though the electric vehicles are popular, the demand from terminals is unsatisfactory and limits the development of the lithium battery industry in turn.

In order to realize fast charge of a power lithium battery pack without a charging station, high reliability and reduced battery grouping effect and obtain a light, compact, easily assembled and conveniently manufactured power system, the invention creatively provides a drive system with a switched reluctance motor using a plurality of rotors as independent power storage devices in mechanical parallel connection to replace the conventional batteries that are simply connected in series to drive a motor through a power converter.

### TECHNICAL PROBLEMS

For the defects in the prior art, an objective of the invention is to provide a light and compact power system that has high fault-tolerant capability and good manufacturing flexibility. In addition, the system uses a switched reluctance motor as a power transformer to efficiently output relatively high power at relatively low system voltage and tolerate differences between the power storage devices.

### SOLUTIONS TO THE PROBLEMS

### Technical Solution

The objective of the invention is realized by the following technical solution: A power system using a switched reluctance motor as a power transformer, comprising a motor controller unit, a power storage device, two power converters and a motor unit, wherein the power storage device, the power converters and the motors are respectively connected with the motor controller unit, one power converter is connected with the power storage device, the other power converter is connected with an external power supply, and the power converters are connected with the motor unit respectively.

The motor unit comprises one or more mechanical parallel motors, and each of the motors is directly connected with the two power converters.

The motor is a switched reluctance motor.

At least one phase of the motor comprises two independent coil windings which are connected with two drive circuits respectively, the two drive circuits are connected with a power storage component and the external power supply respectively, and the motor controller unit controls four-quadrant operation of the motor through two sets of independent power supplies and drive circuits.

The power storage device is capable of being charged and discharged repeatedly.

The power system comprises a master controller, and the motor controller unit receives and executes control signals from the master controller unit, uploads real-time running data collected by the motor controller unit to the master controller, and implements basic control strategies.

The motor is a transformer.

The control strategies comprise a battery management control strategy, a charging control strategy, a power storage module balance control strategy and a maximum solar power tracking control strategy.

### BENEFICIAL EFFECTS OF THE INVENTION

### Beneficial Effects

The beneficial effects of the invention are as follows: the power system is capable of efficiently outputting relatively high power at relatively low system voltage, tolerating relatively large differences between the power storage devices and using various types of power storage devices concurrently; and the system is compact, light and low-cost with high fault-tolerant capability and good manufacturing flexibility.

### BRIEF DESCRIPTION OF THE DRAWINGS

FIG. 1 is a connection block diagram of the power system.

FIG. 2 is a diagram A of the switched reluctance motor running as a transformer.

FIG. 3 is a diagram B of the switched reluctance motor running as a transformer.

### EXAMPLE OF THE INVENTION

### Description of the Preferred Embodiment

The technical solution of the invention is described in detail in combination with accompanied drawings, but the protection scope of the invention is not limited to the following description.

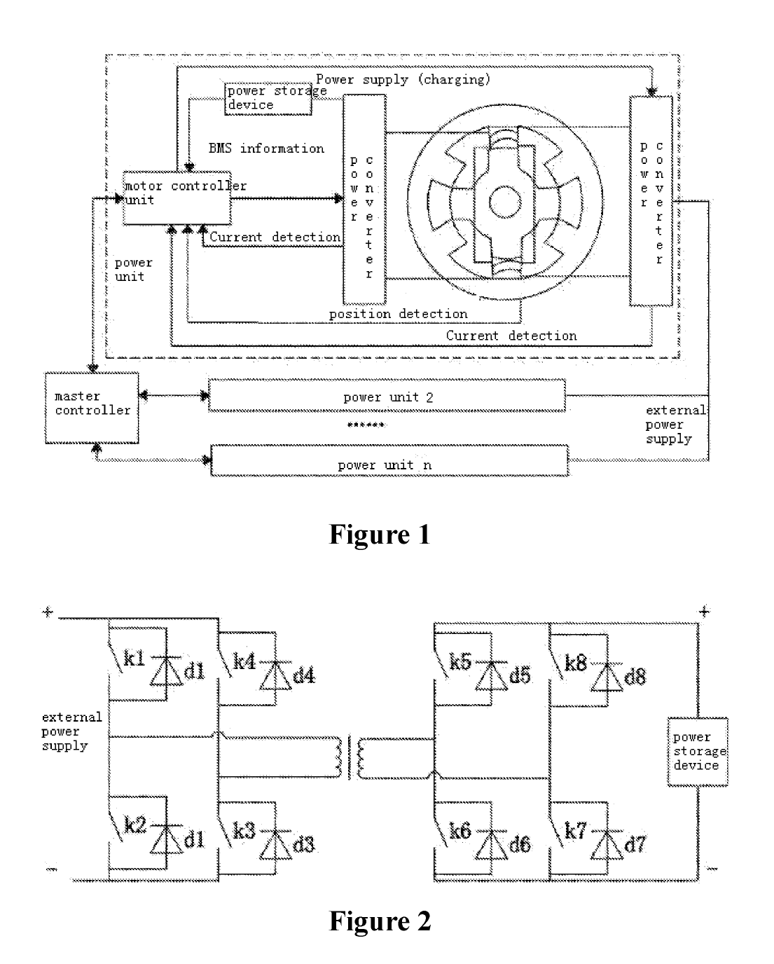

As shown in FIG. 1, a power system using a switched reluctance motor as a power transformer, comprises a motor controller unit, a power storage device, two power converters and a motor unit; the power storage device, the power converters and the motors are respectively connected with the motor controller unit, one power converter is connected with the power storage device, the other power converter is connected with an external power supply, and the power converters are connected with the motor unit respectively.

The motor unit comprises one or more mechanical parallel motors, and each of the motors is directly connected with the two power converters.

The motor is a switched reluctance motor.

At least one phase of the motor comprises two independent coil windings which are connected with two drive circuits respectively, the two drive circuits are connected with a power storage component and the external power supply respectively, and the motor controller unit controls four-quadrant operation of the motor through two sets of independent power supplies and drive circuits.

The power storage device is capable of being charged and discharged repeatedly.

The power system comprises a master controller, and the motor controller unit receives and executes control signals from the master controller unit, uploads real-time running data collected by the motor controller unit to the master controller, and implements basic control strategies.

The motor is a transformer.

The control strategies comprise a battery management control strategy, a charging control strategy, a power storage module balance control strategy and a maximum solar power tracking control strategy.

As shown in FIG. 1, the power system comprises a plurality of power units, the switched reluctance motors in each of the power unit are in mechanical parallel connection, and each of the motors comprises a separate motor controller unit and two power amplifiers respectively.

The motor controller unit controls two sets of independent power supplies to realize four-quadrant operation of the motor. Each of the motor controller units receives and executes specified control signals from the master controller unit, comprising rotating speed control, torque control and rotor position control. At the same time, real-time running data of the motor controller unit are uploaded to the master controller, and each of the controller units collects data of the power system through a communication system and makes basic control strategies. For example, when collecting the data of the power storage devices, a battery management system (BMS) can be used to collect the data of the battery system.

For the basic control strategies, the battery management control strategy is to stop charging when the voltage is over the upper limit during battery charging process, stop discharging when the voltage is under the lower limit during battery cell discharging process, and start the heat-dissipation device, run at a reduced power or stop running when the battery module is overheated. When the controller detects that the parameters reach the upper or lower limits set in the battery management system, the controller takes the appropriate control strategy to ensure that the batteries run safely, reasonably and efficiently.

For the charging control strategy, when the system is charged from an external power supply, in order to ensure that the external power supply is not overloaded, power limits are set in the master controller to maximize the charge rate without overload of the external power supply.

The battery cells can not be exactly the same due to the manufacturing process, the modules are less likely to be the same. Therefore, the power storage module balance control strategy is that all subsystems use appropriate control strategies according to specific power storage systems thereof. The master controller sends different control commands according to the subsystem conditions to ensure that all subsystems can maximize capabilities.

Each motor controller performs personalized operation on the controller command according to the remaining amount of watt-hours (WH) of the internal power storage system, voltage and temperature of each cell, the health of the components as well as practical conditions of the motor controller. For example, when the amounts of remaining WH in the power storage devices are different, the synchronous discharge is performed to maintain an identical state of charge. That is, the power storage devices with a large amount of WH have relatively high discharge power, and the power storage devices with small amount of WH have relatively low discharge power. All of the power storage devices complete the discharge synchronously as possible. When a power storage device reaches an overdischarge threshold, the discharge operation is stopped to avoid any damage, and the motor is driven by the controller to charge the power storage device in power generation mode. Each of the power storage devices is charged independently, and is charged to the optimum state through the motor controller to ensure that all subsystems are able to maximize capabilities with guarantee of safety and service life thereof.

As shown in the system block diagram of FIG. 1, the switched reluctance motor can run in motor mode or generator mode. When the switched reluctance motor runs as a motor with the electricity stored in the power storage component, the system can directly drive the power converter connected with the power storage component through the controller, so as to convert the electricity stored in the power storage component or the external power supply into power. The electricity generated by mechanical power of the input motor can also be fed back to the power storage device or the external power supply when required. For specific operation mode of the reluctance motor, the overall control tasks are assigned to all of the motor controller units for the control objectives through the master controller based on data calculation, and the motor controller units use certain control strategies to control different switching components, so that the motor is available for four-quadrant operation through two independent power supplies.

Because a single-phase switched reluctance motor generally lacks self-startup capability, for practical use, if only one phase of the motor has two windings, the rotor of the reluctance motor can be started with multiple-phase windings, and then the single-phase operation can be enabled by the control system to realize smooth startup.

As shown in FIG. 2, the switched reluctance motor can be used as a transformer, when the electricity stored in the power storage system is converted into alternating current (AC) through four switching components (k5, k6, k7 and k8) and subject to magnetic field coupling in the motor body, an AC voltage is generated in another coil, and the AC is converted into direct current (DC) for charging the external devices after passing through a full-bridge rectification circuit of diodes d1, d2, d3 and d4 connected in parallel to switching components k1, k2, k3 and k4; and when the external power is converted into AC through k1, k2, k3 and k4 and subject to the magnetic field coupling in the motor body, an AC voltage is generated in another coil, and the AC is converted into DC for charging the power storage system after passing through a full-bridge rectification circuit of diodes d5, d6, d7 and d8 connected in parallel to the switching components k5, k6, k7 and k8.

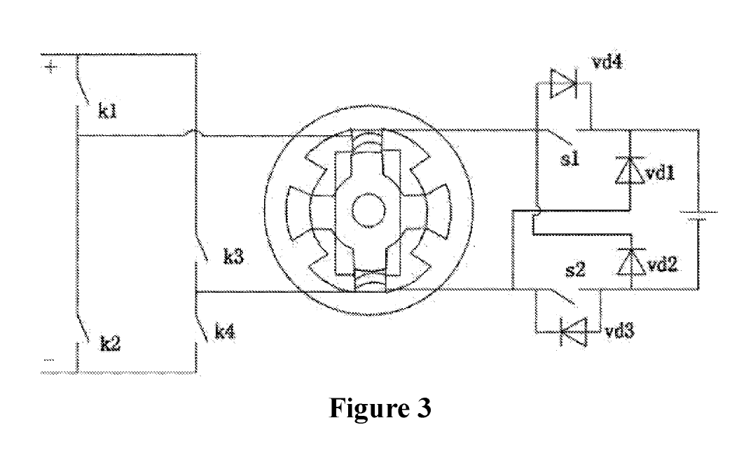

As shown in FIG. 3, the external power is capable of being converted into AC through the k1, k2, k3 and k4 and subject to the magnetic field coupling in the motor body. The AC voltage is generated in a phase winding of the motor. The AC is converted into DC for charging the power storage system after passing through a full-bridge rectification circuit consisting of two freewheel diodes vd4 and vd3 connected in parallel to the switching components as well as two original freewheel diodes vd1 and vd2.

The internal motors in the power system of the invention are in mechanical parallel connection to avoid grouping effects of conventional batteries in series connection. Based on the information provided from the different motor controllers, the master controller controls the batteries to work in different states according to specific conditions. The personalized working conditions ensure that all battery packs area able to work within safe range to avoid the grouping effects.

Meanwhile, the switched reluctance motor can be used as a power transformer to conveniently and rapidly charge the storage power supply from the external power supply at high charging power. Because there are not too many parts, the overall system can be rapidly charged at low voltage and high power with a little additional weight. If the switched reluctance motors are used in electric vehicles, the motors are also easy to be charged from the conventional power grid and convenient to be used.

1. A power system using a switched reluctance motor as a power transformer, characterized in that the power system comprises a motor controller unit, a power storage device, two power converters and a motor unit, the power storage device, the power converters and the motors are respectively connected with the motor controller unit, one power converter is connected with the power storage device, the other power converter is connected with an external power supply, and the power converters are connected with the motor unit respectively.

2. The power system using a switched reluctance motor as a power transformer according to claim 1, characterized in that the motor unit comprises one or more mechanical parallel motors, and each of the motors is directly connected with the two power converters.

3. The power system using a switched reluctance motor as a power transformer according to claim 2, characterized in that the motor is a switched reluctance motor.

4. The power system using a switched reluctance motor as a power transformer according to claim 2, characterized in that at least one phase of the motor comprises two independent coil windings which are connected with two drive circuits respectively, the drive circuits are connected with a power storage component and the external power supply respectively, and the motor controller unit controls four-quadrant operation of the motors through two sets of independent power supplies and drive circuits.

5. The power system using a switched reluctance motor as a power transformer according to claim 1, characterized in that the power storage device is capable of being charged and discharged repeatedly.

6. The power system using a switched reluctance motor as a power transformer according to claim 1, characterized in that the power system comprises a master controller, and the motor controller unit receives and executes control signals from the master controller unit, uploads real-time running data collected by the motor controller unit to the master controller, and implements basic control strategies.

7. The power system using a switched reluctance motor as a power transformer according to claim 2, characterized in that the motor is a transformer.

8. The power system using a switched reluctance motor as a power transformer according to claim 6, characterized in that the control strategies comprise a battery management control strategy, a charging control strategy, a power storage module balance control strategy and a maximum solar power tracking control strategy.
